(19) United States
(12) Patent Application Publication
(10) Pub. No.: US 2026/0292024 A1
(43) Pub. Date: Sep. 24, 2026

(54) METHOD FOR USING RDMA ON FRONTHAUL INTERFACE

(71) Applicant: TELEFONAKTIEBOLAGET LM ERICSSON (PUBL), STOCKHOLM (SE)

(72) Inventors: Dániel Géhberger, Montreal (CA); Martin Julien, Montreal (CA); Bartosz Podrygajlo, Ottawa (CA)

(21) Appl. No.: 19/477,417

(22) PCT Filed: Apr. 21, 2023
(86) PCT No.: PCT/IB2023/054115

§ 371 Date: Oct. 21, 2025

(51) Int. Cl. H04L 67/1097; G06F 15/173

(52) U.S. Cl. CPC H04L 67/1097; G06F 15/17331

(57) ABSTRACT

A method is provided performed by a distributed device communicatively connected to at least one of a radio device and radio gateway over a fronthaul interface in a telecommunication network. The method includes performing at least one of the following (i) receiving data via remote direct memory access, RDMA, in a first memory of the distributed device from a second memory of at least one of the radio device and the radio gateway, and (ii) transferring the data via RDMA from the first memory of the distributed device to at least one of the second memory of at least one of the radio device and the radio gateway. Related methods and apparatus are also disclosed.

### TECHNICAL FIELD

The present disclosure relates generally to method performed by a distributed device connected to at least one of a radio device and a radio gateway over a fronthaul interface in a telecommunication network for using remote direct memory access (RDMA), and related methods and apparatuses.

### BACKGROUND

With the fourth generation (4G)/fifth generation (5G), significant changes have been introduced regarding how mobile networks are designed. 4G/5G opened a possibility for the radio access network (RAN) to be implemented in a split architecture relying on virtualized/cloud commercial off the shelf (COTS) hardware components; which may continue in future network generations.

FIG. 1 is a schematic diagram of an example of a split RAN architecture showing high-level components of a RAN design, including a radio unit (RU) 108 (also referred to herein as a “radio device”), a distributed unit (DU) 106 (also referred to herein as a “distributed device”), and a central unit (CU) 104 (also referred to herein as a “central device”). In FIG. 1, the RAN is connected to the core network (core) 102 via a backhaul interface (shown in FIG. 1 as “backhaul”). The CU 104 is connected to the DU 106 via a midhaul interface (shown in FIG. 1 as “midhaul”); and the DU 106 is connected to the RU 108 via a fronthaul interface (shown in FIG. 1 as “fronthaul”). The RU 108 is communicatively connected to a user equipment (UE) 110 via an air interface. Uplink (UL) and downlink (DL) directions are also shown in FIG. 1. The actual distribution of functions for control and data planes between the components in the RAN depend on the implemented functional split. For example, in open-RAN (O-RAN) a 7.2× functional split is used but other splits may be used.

With regard to the fronthaul interface between a RU and a DU, the actual function distribution between the DU and the RU depends on the used lower layer split. In some approaches, the function distribution is generalized such that a “higher” partition of the physical layer is implemented in the DU while a “lower” partition is in the RU. Communication in the fronthaul became packet switched with 5G using Ethernet, compared to point-to-point connections in previous networks. In some approaches, the protocol used in O-RAN on the fronthaul is enhanced common public radio interface (eCPRI), either directly over Ethernet or over internet protocol (IP)/user datagram protocol (UDP). Other implementations may include proprietary implementations that may use different protocols on the fronthaul over Ethernet.

### SUMMARY

Some embodiments provide a method performed by a distributed device communicatively connected to at least one of a radio device and radio gateway over a fronthaul interface in a telecommunication network. The method includes performing at least one of the following (i) receiving data via RDMA in a first memory of the distributed device from a second memory of at least one of the radio device and the radio gateway, and (ii) transferring the data via RDMA from the first memory of the distributed device to at least one of the second memory of at least one of the radio device and the radio gateway.

Other embodiments provide a distributed device comprising at least one processor and a first memory connected to the at least one processor to perform operations comprising to perform at least one of the following (i) receive data via RDMA in a first memory of the distributed device from a second memory of at least one of the radio device and the radio gateway, and (ii) transfer the data via RDMA from the first memory of the distributed device to at least one of the second memory of at least one of the radio device and the radio gateway.

Other embodiments provide a computer program comprising program code to be executed by at least one processor of a distributed device. The at least one processor causes the distributed device to perform operations comprising to perform at least one of the following (i) receive data via RDMA, in a first memory of the distributed device from a second memory of at least one of the radio device and the radio gateway, and (ii) transfer the data via RDMA from the first memory of the distributed device to at least one of the second memory of at least one of the radio device and the radio gateway.

Some embodiments provide a computer program product comprising a non-transitory storage medium connected to at least one processor of a distributed device. The at least one processor causes the distributed device to perform operations comprising to perform at least one of the following (i) receive data via RDMA in a first memory of the distributed device from a second memory of at least one of the radio device and the radio gateway, and (ii) transfer the data via RDMA from the first memory of the distributed device to at least one of the second memory of at least one of the radio device and the radio gateway.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a split RAN architecture;

FIG. 2A is a schematic diagram illustrating an example of cloud-based RAN look-aside acceleration according to some embodiments;

FIG. 2B is a schematic diagram illustrating an example of cloud-based RAN inline acceleration according to some embodiments;

FIG. 3 is a schematic diagram illustrating an example system architecture according to some embodiments;

FIG. 4 is a sequence diagram illustrating an example for RDMA on an UL fronthaul according to some embodiments;

FIG. 5 is a sequence diagram illustrating an example for RDMA on an UL fronthaul that includes a radio gateway according to some embodiments;

FIG. 6 is a sequence diagram illustrating an example for RDMA on a DL fronthaul according to some embodiments;

FIG. 7 is a sequence diagram illustrating an example for RDMA on a DL fronthaul that includes a radio gateway according to some embodiments;

FIG. 8 is a sequence diagram illustrating an example for RDMA on a DL fronthaul with memory pools according to some embodiments;

FIG. 9 is a flow chart illustrating operations of a distributed device according to some embodiments;

FIGS. 10-14 are flow charts illustrating operations of a distributed device according to some embodiments;

FIG. 15 is a block diagram of a communication system in accordance with some embodiments;

FIG. 16 is a block diagram of a UE in accordance with some embodiments;

FIG. 17 is a block diagram of a network node in accordance with some embodiments; and

FIG. 18 is a block diagram of a virtualization environment in accordance with some embodiments.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents some embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

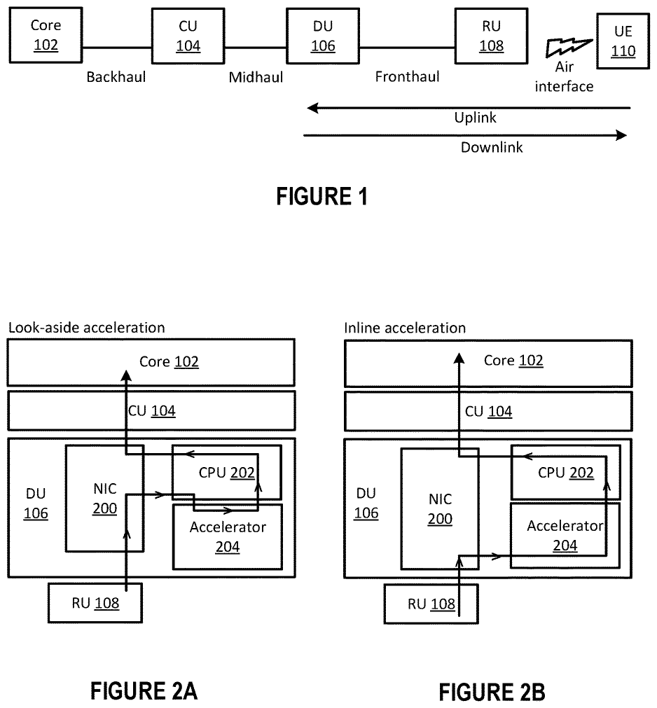

FIG. 2A is a high-level schematic diagrams for traffic going through a DU (e.g., DU 106 of FIG. 1) in a cloud-based RAN. Certain parts of the functionality that resides in the DU may be efficiently accelerated using hardware accelerators such as graphics processing units (GPUs), field programmable gate arrays (FPGAs), or application specific integrated circuits (ASICs). Such components include, for example, low density parity check (LDPC) decoding or cyclic redundancy check (CRC) validation. FIG. 2A illustrates use of a memory (in accelerator 204 in this example) as a look-aside device where on the UL, as shown by the line with arrows in FIG. 2A, traffic is received via a network interface card (NIC) 200 on a central processing unit (CPU) 202 first, copied to the accelerator 204, and then the results of a computation are copied back to the CPU 202.

In contrast to FIG. 2A, FIG. 2B shows inline acceleration, where on the UL, as shown by the line with arrows in FIG. 2B, data is directly copied to a memory (in accelerator 204 in this example) from the NIC 200, which can save time, energy, and bandwidth on a peripheral component interconnect express (PCIe) bus connection of components in a given server. In the DL direction, a similar operations can be performed where data is taken directly from the accelerator 204 to the NIC 200 towards the RU 108 for inline acceleration.

In examples of the present disclosure, supporting inline and/or look-aside acceleration includes a direct copy into/from at least one memory. Such a direct copy mechanism includes RDMA that enables reading and writing exposed memory of another device.

RDMA has been used in InfiniBand networks accessing the main memory of remote servers. More recently, RDMA became available over Ethernet (for example, as RDMA over converged Ethernet (RoCEv2) or iWARP, a computer networking protocol that implements RDMA and runs over transmission control protocol (TCP)). Some COTS NICs support RoCEv2/iWARP.

While in some examples of the present disclosure, the term RDMA is used in connection with a fronthaul interface defined over Ethernet, the present disclosure is not so limited and includes other implementations, such as RoCEv2 or iWARP.

In some approaches, RDMA has a variant referred to as peer-to-peer RDMA that enables RDMA copies between devices in a single server, such as a NIC and an accelerator.

Further, an eCPRI standard (see e.g., http://www.cpri.info/downloads/eCPRI_v_2.0_2019_05_10c.pdf) defines Message Type 4: Remote Memory Access that enables reading and writing from/to the memory of a remote node. The standard, however, lacks implementation details on the hardware and driver level.

Other approaches may include enabling RDMA between a UE and the network via xNB (RAN); or placing a placeholder frame in a transmission queue of a wireless node that is filled in later in time before transmission via RoCE.

There currently exist certain challenges. Approaches are lacking for data exchange efficiency on a fronthaul interface. For example, data exchange efficiency may be lacking for inline acceleration and/or look-aside acceleration on a fronthaul interface for telecommunications network deployments.

Inline acceleration for RAN deployments, for example, may be more efficient than look-aside acceleration but needs data to be copied directly into at least one memory (of an accelerator, for example) to be efficient.

While the functional steps of the higher part of the physical layer in a DU operate on radio slots, fronthaul protocols such as eCPRI break these slots into smaller messages to be transmitted over Ethernet (or IP). eCPRI messages may be limited to 65 kB due to a fragmentation limit of the IP layer. At the same time, highly-loaded radio slots may contain over a megabyte of data. Using peer to peer RDMA, the fragments can be written to an accelerator memory from the NI, but the data typically is scattered, padded, and contains headers. For efficient acceleration of the functional steps, it may need to be re-aligned or indirections/lookup tables may be needed.

Thus, a limitation of a remote memory access type of eCPRI includes the length limitation, as well as that hardware-based implementation needs a custom hardware/driver design, thus limiting the use of COTS components. RDMA, however, can be supported on various hardware (e.g., COTS hardware) without limitations (e.g., such as a message length limitation). For efficient use of RDMA on a fronthaul interface (e.g. for inline and/or look-aside acceleration), data of an arbitrary length may need to be copied directly into a memory (e.g., of an accelerator or a CPU) as a single memory operation, accelerated by hardware.

Certain aspects of the disclosure and their embodiments may provide solutions to these or other challenges. The present disclosure relates to a system and method for using RDMA on a fronthaul interface between a RU and at least one memory (e.g., in an accelerator) of a DU. An objective is to enable the use of hardware accelerated by way of a data transfer (e.g., a large data transfer) via RDMA (e.g., RoCEv2). Using RDMA can eliminate a need for software-based packet creation, packet reception/reordering, and data alignment steps in software components as RDMA is implemented in hardware and may ensure that the transmitted data arrives as a single buffer. Moreover, using RDMA for inline and/or look-aside acceleration may reduce processing cycles (e.g., CPU cycles) needed to handle fragments since RDMA happens without processor involvement; and use of RDMA may eliminate a need to re-assemble fragments.

As referred to herein, RDMA can be used to copy data directly from an RU to any memory of a DU on the UL (e.g., not limited to an accelerator memory). While some examples herein focus on a memory of a hardware accelerator, other types of memories can be used such as a regular CPU memory (e.g., dynamic random access memory (DRAM)) or persistent memory (PMEM), for example. Such other types of memories may be used, for example, if accelerator functionality becomes integrated into a CPU.

As referred to herein, the terms “distributed unit” or “DU” are interchangeable with the term “distributed device” and refer to a network node in a telecommunications network having distributed or virtual network functions; and the terms “radio unit” or “RU” are interchangeable with the term “radio device” and refer to a network node in a telecommunications network having radio functions. For example, in O-RAN, a network node can include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof. The network node may support a specification by, for example, supporting an interface defined by the O-RAN specification, such as an A1, F1, W1, E1, E2, X2, Xn interface, an open fronthaul user plane interface, or an open fronthaul management plane interface. Moreover, an O-RAN network node may be a logical node in a physical node. Furthermore, an O-RAN network node may be implemented in a virtualization environment (described further herein) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes can facilitate direct or indirect connection of UEs, such as by connecting a UE to a core network over one or more wireless connections, as discussed further herein.

Some examples discussed herein include both UL and DL communication directions. As discussed further herein, a communication pattern may be different for UL and DL.

On the UL, for example, upon completion of a medium access control (MAC) layer scheduling in a DU node for a given slot, the amount of expected data can be calculated, and a memory area reserved from a memory. The address of the memory area can then be exposed to a RU node and, in turn, the RU node can use RDMA to directly copy the slot data to the memory of the DU node.

On the DL, for example, upon completion of MAC layer scheduling in the DU node for a given slot, the amount of expected data can be calculated, and an RDMA capable memory buffer can be requested from the RU node. At the same time, a higher part of the physical layer can be processed on the DU node. Once the processing is complete and the memory address is received, RDMA can be used to copy data from a DU memory to a RU memory, and then the lower part of the physical layer processing is triggered.

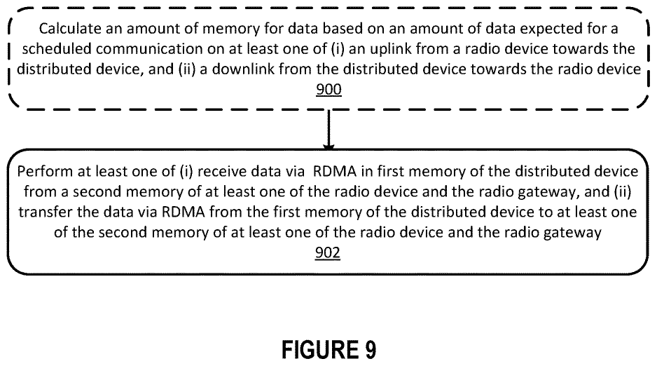

Some embodiments are directed to a method performed by a distributed device. As illustrated in FIG. 9, a method is performed by a distributed device communicatively connected to at least one of a radio device and radio gateway over a fronthaul interface in a telecommunication network. The method includes performing (902) at least one of the following (i) receiving data via RDMA in a first memory of the distributed device from a second memory of at least one of the radio device and the radio gateway, and (ii) transferring the data via RDMA from the first memory of the distributed device to at least one of the second memory of at least one of the radio device and the radio gateway.

In some embodiments, the method further includes calculating (900) an amount of memory for the data based on an amount of the data expected for a scheduled communication on at least one of (i) an UL from the radio device towards the distributed device, and (ii) a DL from the distributed device towards the radio device.

The performing (902) may include receiving the data on an UL of the fronthaul interface via RDMA from the second memory of the radio device to the first memory of the distributed device.

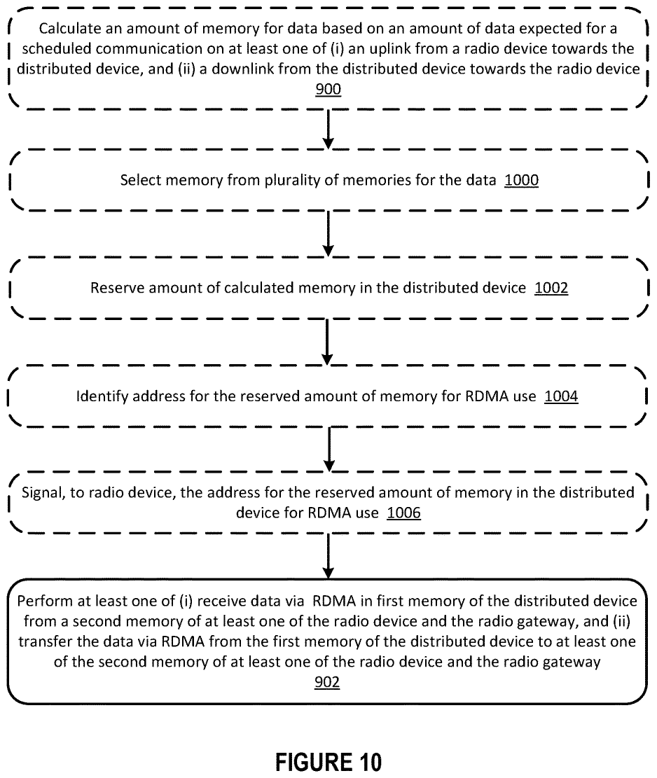

Referring to FIG. 10, in some embodiments, the method further includes reserving (1002) the amount of calculated memory in the distributed device; and identifying (1004) an address for the reserved amount of memory for RDMA use.

In some embodiments, the reserved memory in the distributed device includes a plurality of memories, and the method further includes selecting (1000) a memory from the plurality of memories for the data.

Reserving (1002) an amount of memory may include at least one of (i) reserving an amount of memory in the first memory of the distributed device, (ii) reserving a maximum amount of data in the first memory, (iii) reserving at least one memory pool for the data, and (iv) reserving a plurality of memory pools in the first memory of the distributed device.

The identifying (1004) the address may include at least one of (i) identifying a memory address in the distributed device for the RDMA, (ii) identifying an identifier of a location in the first memory of the distributed device for the RDMA, and (iii) identifying a plurality of memory addresses in the distributed device for the RDMA.

In some embodiments, the method further includes signalling (1006), to the radio device, the address for the reserved amount of memory in the distributed device for RDMA use.

Receiving the data on the UL of the fronthaul interface via RDMA in the first memory of the distributed device may include a single RDMA write operation.

Technical advantages provided by certain embodiments of the present disclosure may include that based on use of RDMA on the fronthaul interface, enhanced performance (e.g., low latency, low PCIe bandwidth use) may be obtained, for example, on a fronthaul UL data channel via RDMA from a RU to a DU memory (e.g., in an accelerator). Further technical advantages may include power savings based on relying on accelerated data transfer compared to using a CPU, for example, for managing the data transfer. Furthermore, compared to a non-RDMA setup, CPU use may be less, thus resulting in power savings. Moreover, based on use of RDMA on the fronthaul interface, implementation of certain embodiments can be implemented with COTS hardware on the DU side, thus enabling implementation in the cloud (e.g., cloud-based RAN). Yet further technical advantages may include removing a need for software-based fragmentation, frame creation on the RU side, header removal, and/or data ordering on the DU side for an UL data channel. Another technical advantage may include that certain embodiments may be compatible with standard interfaces with the inclusion of a radio gateway.

In 5G, communication in time domain over the air interface happens in frames (e.g., 10 ms) that are divided to subframes (e.g., 10 subframes/1 ms each). The subframes are divided into slots based on a used numerology (e.g., 1/2/4/8 slots). Finally, one slot can have 12/14 orthogonal frequency division multiplexing (OFDM) symbols. It is noted that 5G enables allocation on a symbol level, which may be important for ultra reliable low latency communication (URLLC). In the frequency domain, a given bandwidth part can be used with a configured number of subcarriers depending on the numerology. Allocation can occur on the level of resource block groups (RBG) that are groups of physical resource blocks (PRB), where a PRB has 12 subcarriers.

On an UL data channel, the RU can transform received radio frequency (RF) signals using lower physical layer functions and then the symbols can be transmitted to the DU for higher physical layer processing. On this higher part of the physical layer, functions (such as LDPC decoding) can be executed on the level of slots, resulting in periodic tasks based on the numerology with a strict deadline. The use of accelerators and high-performance networking options may be needed to keep the processing deadlines, especially in mid and high frequency bands with higher numerologies.

Similarly for a DL data channel, the DU may rely on an accelerator to execute the higher physical layer functions, then the symbols can be transferred to the RU that executes the lower physical layer functions and then transmits on RU towards the UE(s).

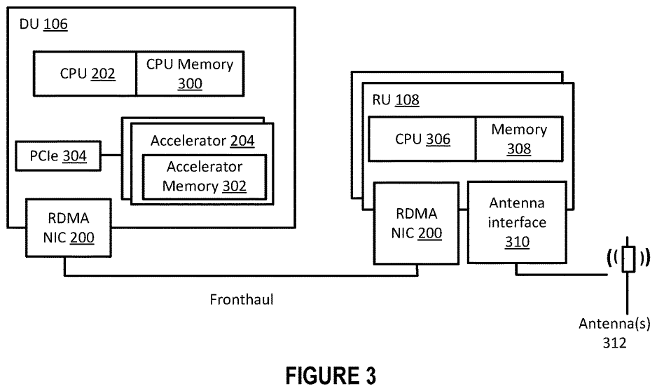

FIG. 3 is a schematic diagram showing an example of a system architecture according to some embodiments of the present disclosure. As shown, the DU 106 is connected to one or more RUs 108 over a fronthaul interface via RDMA capable NICs 200. The RU(s) 108 are also connected to antennas 312 (e.g., 64 antennas) on separate interfaces 310. The DU 106 may run in a physical or a virtualized (e.g., virtual machine, container) environment which includes the RDMA capable NIC 200, a general-purpose CPU 202 with associated memory 300, an accelerator 204 (e.g., GPU, FPGA, ASIC) with associated memory 302 and an internal interconnect 304 (e.g., PCIe). RU(s) 108 can be a purpose-built hardware (e.g., ASIC) with associated memory 308 and processing components 306. RU(s) 108 is also equipped with an RDMA NIC 200.

5G can enable both dynamic and configured scheduling for UL and DL. In an example, on the UL in dynamic scheduling, a UE(s) requests UL transmission resources on a physical uplink control channel (PUCCH) or a physical random access channel (PRACH) on demand and receive grants on a physical downlink control channel (PDCCH) via downlink control information (DCI). For DL, a UE is signaled on the PDCCH via DCI that resources have been allocated on a physical downlink shared channel (PDSCH). In case of configured scheduling or semi-static scheduling), the UE(s) are allocated periodic resources on the PUSCH/PDSCH by radio resource control (RRC) signaling.

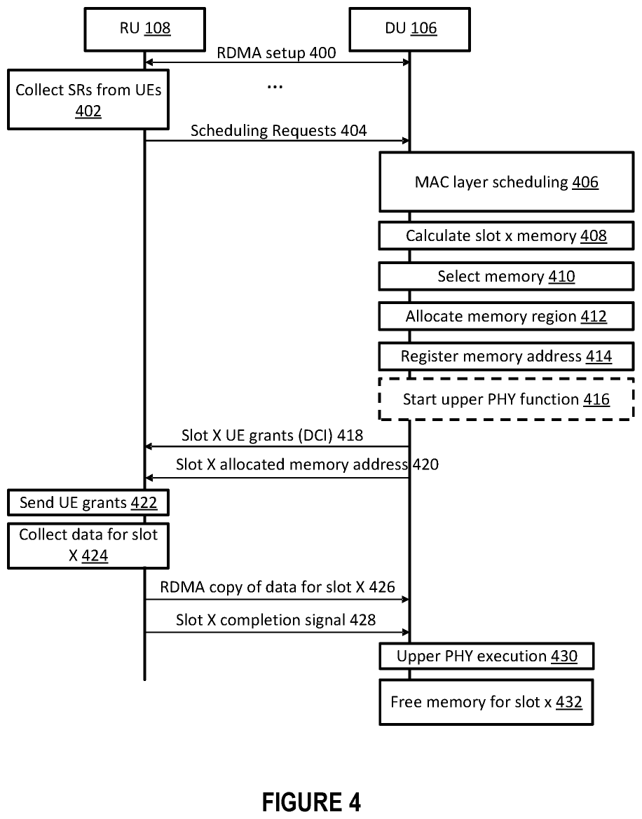

FIG. 4 is a sequence diagram showing an example of RDMA on an UL fronthaul. This example is shown for dynamic scheduling between RU 108 and DU 106 to support RDMA from an RU memory (e.g., memory 308) to a memory of DU 106 (e.g., accelerator memory 302) of DU 106. It is noted that the DU also may have more than one memory (e.g., in more than one accelerator) available, in which case the memory to be used for a given transfer (e.g., for given slot of a given RU) is selected by the DU.

While RDMA enables direct memory copies, RDMA needs an out of band method, such as communication management, to negotiate parameters between the endpoints. In the example in FIG. 4, during initialization in operation 400, an RDMA setup done for example via an RDMA connection manager or via a custom method such as via vendor-specific message types of the used fronthaul protocol (e.g., eCPRI extension or other vendor-specific protocol). The RDMA connection between the RU 108 and the DU 106 may be kept alive for a long time. A memory address to be addressable via RDMA may need to be registered via an RDMA application interface (API) (e.g., verbs API).

On the UL direction, in operation 402, the RU 108 samples the air interface collecting data on different physical layer channel, including the physical uplink control channel (PUCCH) and the physical random access control channel (PRACH). Attached UE(s) that request dynamic allocation use the PUCCH or the PRACH to send scheduling requests. In operation 404, RU 108 sends the collected information from the UE(s) on the UL channels to the DU 106.

In this example, in operation 406, a scheduler in DU 106 is responsible for scheduling a UE(s) for PUSCH transmission using grants transmitted to the UE(s) over the PDCCH (via DCI, for example). The scheduler may be for MAC layer scheduling for dynamic and/or configured scheduling UE(s). An allocation or grant enables a selected UE to transmit on the PUSCH using a given transport format over the given resources (symbols in time domain and RBGs in the frequency domain). The scheduler also adds a UE(s) with a configured scheduling option, for which configuration (e.g., assigned resources, layers, etc.) is known by the scheduler.

Based on the scheduling decision, in operation 408, an amount of data expected from the RU 108 can be calculated for a slot (e.g., for slot X memory requirements). An algorithm to calculate the amount of data (e.g., number of bytes expected) depends on the implemented lower layer split, number of multiple input multiple output (MIMO) layers, RBGs, data symbols, and/or modulation and coding (e.g., sample size), for example. There may be additional data requirements for each UE allocated for the slot.

Upon completion of the scheduling in the example in FIG. 4, in operation 412, DU 106 reserves this calculated amount of memory for the slot from the memory (e.g., from an accelerator). If more than one memory (e.g., in more than one accelerator) is present in the DU 106, in operation 410, DU 106 selects a memory for the given slot. The selection may be guided by available memory, available compute capacity, power considerations or a mix of these (e.g., one accelerator is expected to handle a highly loaded slot better than another that is more performance efficient for lightly loaded slots). In operation 414, a memory address for the reserved memory is registered for RDMA use.

Implementation can include different options including:
For simplification the DU 106 may always reserve a pre-determined amount of bytes that can store the maximum amount of data for a slot (e.g., largest sample size, frequency and time domain allocation and MIMO layers).
One or more memory pools may be used with pre-allocated data segments in order to avoid costly memory allocation via allocators and the RDMA reservation. Memory pools may be created with different memory sizes and a buffer from the smallest that can host the calculated amount of data may be used for a given slot.
The DU 106 may share a memory allocation lookup table in advance and refer to allocated locations with identifiers (IDs) instead of providing memory addresses for each slot.
If memory regions are fixed sized and pre-reserved, the DU 106 may transmit memory addresses for multiple future slots as a batch.

In operation 416, in the example in FIG. 4, DU 106 optionally can start the upper physical layer function for the given slot on the memory (e.g., accelerator) in a blocked mode. The function can remain blocked until it is signaled, either after all the data arrives from the RU 108 or because of a timeout. If the used method or blocking method permits, for inline and/or look-aside acceleration, the function may be blocked on a flag that can be set via RDMA. The flag may be part of the allocated memory region. In this event, for inline acceleration, a CPU of the DU 106 is not needed to take an active part in the upper physical layer processing of the slots and, thus, some energy may be saved.

In operation 418, the scheduling decisions (UE grants in FIG. 4) for slot X are transmitted to the RU 108 via the PDCCH. In operation 420, DU 106 transmits to RU 108 the RDMA capable memory address of the allocated memory for slot X. This can be done, for example, via a vendor-specific message type. For example, if eCPRI is used in an implementation, this can be a Type #4 Remote Memory Access with read/write field set to one of the type codes not currently used in the specification, element ID used to identify the slot, the address field set to the RDMA address and length set to 0.

In operation 422, RU 108 forwards the grants to the scheduled UEs and stores the received RDMA address for slot X. When the time for slot X arrives, in operation 424, RU 108 receives the data from the UEs over the PUSCH and stores the data in memory. RU 108 may align the data already in memory in a way that will enable easy processing for the upper physical layer functions in the DU 106. For example, aligning data (e.g., PRBs for different MIMO layers) in a way that a LDPC decoding step can efficiently use.

Once RU 108 collected and processed via the lower physical layer all the data received from the UEs for slot X, in operation 426, RU 108 transfers the data for slot X via RDMA to the DU 106 memory (e.g., accelerator). The transfer may be done via a single RDMA write operation.

After the transfer, RU 108 triggers processing of slot X on the DU 106 side. This operation is included since, due to the nature of RDMA, a CPU or the execution unit on the accelerator of the DU 106 are not aware of the data transfer itself. Different implementations for the triggering can be included. If permitted by the used method or blocking method, the triggering can be done via RDMA, for example if the function is being blocked on a flag in memory, then this flag can be set via RDMA (e.g., as part of a single memory operation that transfers the data (via the last bytes copied)). In another example implementation, the triggering can be done via a regular message (e.g., eCPRI or the used fronthaul protocol) that results in the DU 106 executing/unblocking the function for slot X.

After execution of the higher physical layer functions on the memory (e.g., accelerator), in operation 430, the resulting data is copied to the memory of a CPU, for example, for higher layer processing. In operation 432, the allocated memory for slot X is freed or handed back to, e.g., a memory pool and can be re-used for future slots.

It is noted that a timeout can occur for a given slot if not all the expected data arrives from the scheduled UE(s). Slots with missing data still can be processed as data can be partially recovered. On the RU 108 side, if a loss is detected, then the RDMA copy can still be performed (e.g., with missing data marked or set to 0) and the DU 106 processing can be triggered. If timeout occurs on the DU 106 side, then the memory for slot X may be examined and if data from the RU 108 is partially present (e.g., the trigger is lost) then the processing can be triggered; otherwise the entire slot can be marked as lost. In case of timeout, the RDMA address may be deregistered from RDMA or locked by some means in order to prevent a late write to conflict with the already started processing.

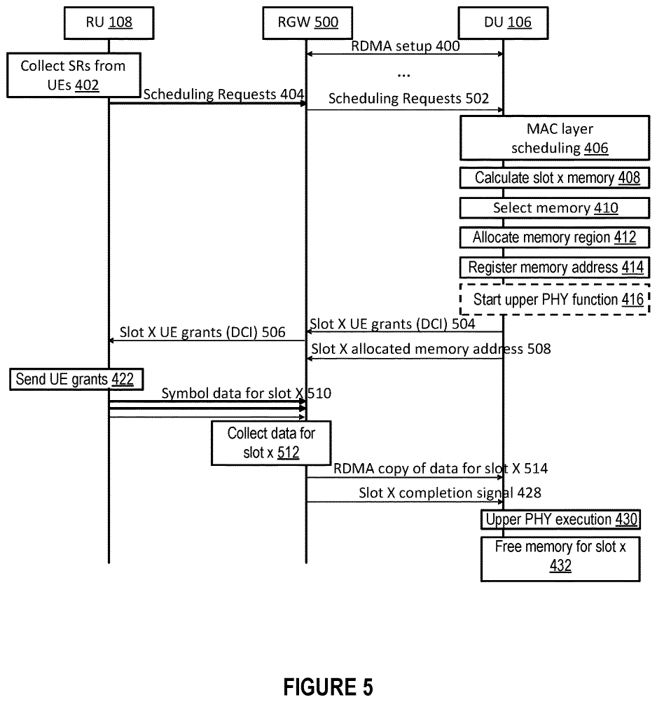

FIG. 5 is sequence diagram for an alternative example for cases where an RU 108 does not support the RDMA operation (e.g., it is not equipped with an RDMA NIC). As shown in FIG. 5, in this example, a radio gateway 500 (RGW) is added between the RU 108 and the DU 106. The RDMA operation happens in operation 514 between the RGW 500 and the DU 106; and, in operation 502, the RGW 500 forwards the scheduling request(s) received in operation 404 from the RU 108 to the DU 106. When UE grants for slot X are received by the RGW 500 in operation 504, RGW 500 forwards in operation 506 the grants except the allocated memory address to the RU 108. In various examples herein, optionally, RGW 500 performs further processing on the data before forwarding. Once the data from the UE(s) on the PUSCH for slot X is collected in operations 510 and 513 in the RGW 500, RGW 500 uses the RDMA write previously discussed with reference to FIG. 4 in operation 514 to copy to the memory (e.g., accelerator) of the DU 106. In implementation examples, RGW 500 may be a regular server, or a SmartNIC in the DU 106 server, such as a data processing unit or an infrastructure processing unit. A SmartNIC can be equipped with programmable processors and, thus, can act as a gateway between the RU 108 and the DU 106.

In some embodiments, for example, performing (operation 902 in FIG. 9) includes receiving the data on an UL of the fronthaul interface via RDMA from the second memory of the radio gateway to the first memory of the distributed device. Referring to FIG. 10, in some embodiments, the method further includes reserving (1002) an amount of calculated memory in the distributed device; and identifying (1004) an address for the reserved amount of memory for RDMA use. The reserved memory in the distributed device can include a plurality of memories, and the method can further include selecting (1000) a memory from the plurality of memories for the data. Reserving (operation 1002 in FIG. 10) an amount of memory can include at least one of (i) reserving an amount of memory in the first memory of the distributed device, (ii) reserving for a specified maximum amount of data in the first memory, (iii) reserving at least one memory pool for the data, and (iv) reserving a plurality of regions in the first memory of the distributed device. Identifying (operation 1004 in FIG. 10) the address can include at least one of (i) identifying a memory address in the distributed device for the RDMA, (ii) identifying an identifier of a location in the first memory of the distributed device for the RDMA, and (iii) identifying a plurality of memory addresses in the distributed device for the RDMA.

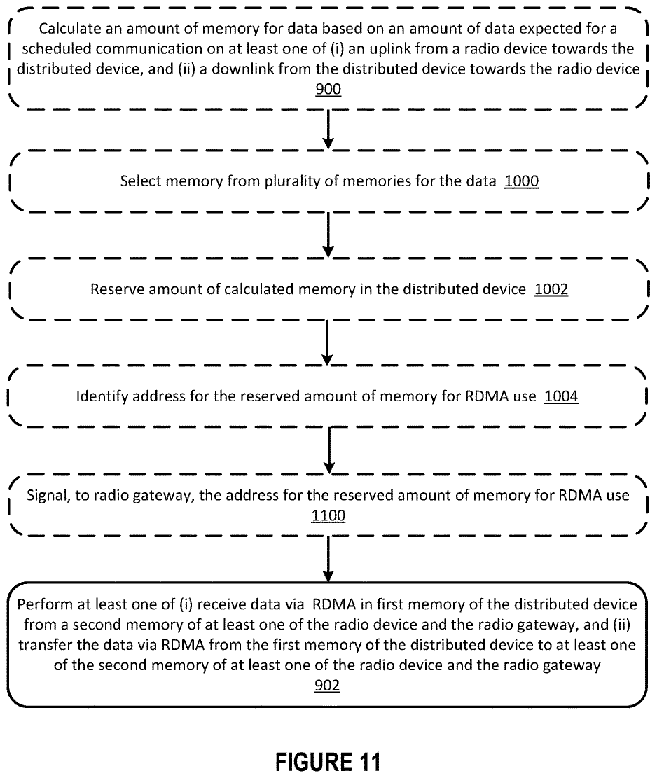

Referring to FIG. 11, in some embodiments, the method further includes signalling (1100), to the radio gateway, the address for the reserved amount of memory for RDMA use.

In some embodiments, receiving the data on the UL of the fronthaul interface via RDMA in the first memory of the distributed device includes a single RDMA write operation.

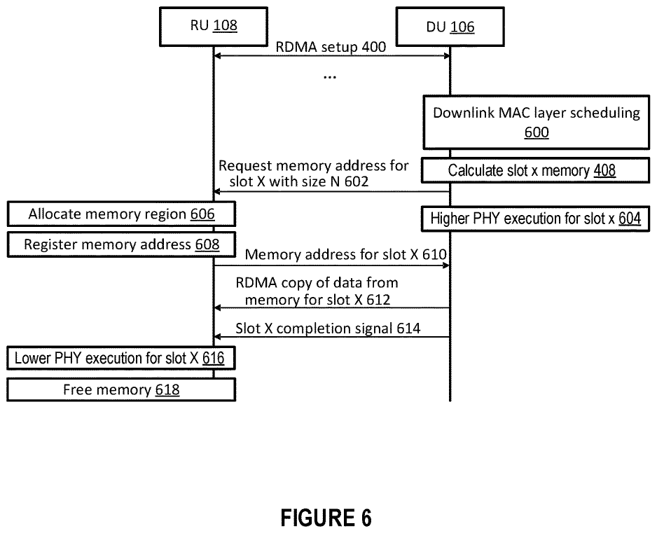

FIG. 6 is a sequence diagram showing an example of RDMA on a DL fronthaul. Similar to the UL example of FIG. 4, in operation 400, the RDMA connection can be created during the initialization. On the DL, MAC layer scheduling 600 can take into account both dynamic and configured scheduling UEs. Based on the scheduling result, an amount of memory can be calculated in operation 408 (e.g., the number of bytes expected from the RU 108 for slot X). Similar to UL, an algorithm to calculate the amount of memory for the expected data depends on the implemented lower layer split, number of MIMO layers, RBGs, data symbols, and/or the modulation and coding (e.g., sample size). There may be additional data requirements for each UE allocated for the slot.

DU 106, in operation 602, requests a memory region for slot X with size N from the RU 108. While the RU 108 allocates, registers, and sends the memory address in operations 606-610, the DU 106 in operation 604 can execute the higher physical layer processing for slot X using the memory (e.g., accelerator). Once the processing is complete and the address is received, in operation 612, the DU 106 uses RDMA to copy the symbols of the slot from the memory (e.g., accelerator) to the RU 108 memory and, in operation 614, signal the completion. In operations 616 and 618, the RU 108 executes the lower physical layer functions and frees the memory for slot X.

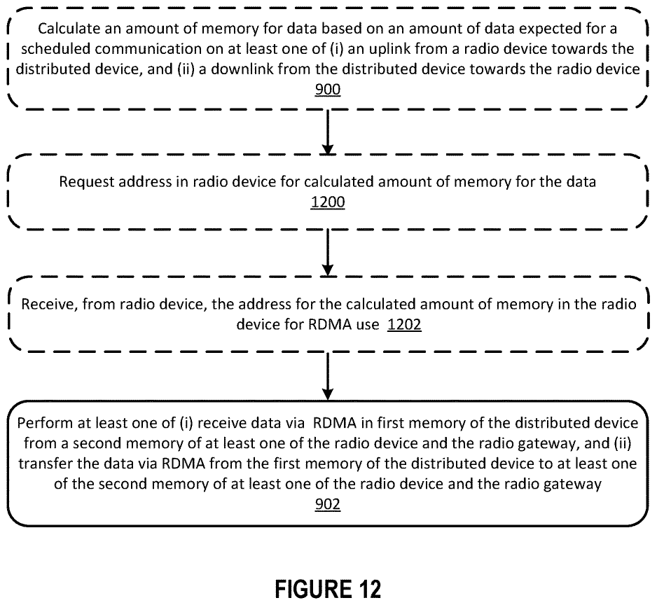

In some embodiments, performing (operation 902 in FIG. 9) includes transferring the data on a DL of the fronthaul interface via RDMA from the first memory of the distributed device to the second memory of the radio device. Referring to FIG. 12, in some embodiments, the method further includes requesting (1200) an address in the radio device for the calculated amount of memory for the data; and receiving (1202), from the radio device, the address for the calculated amount of memory in the radio device for RDMA use.

The calculated amount of memory can include at least one of (i) an amount of memory in the second memory of the radio device, (ii) a maximum amount of data in the second memory of the radio device, (iii) at least one memory pool for the data, and (iv) a plurality of regions in the second memory of the radio device.

The address can include at least one of (i) a memory address in the radio device for the RDMA, (ii) an identifier of a location in the second memory of the radio device for the RDMA, and (iii) a plurality of memory addresses in the radio device for the RDMA.

Transferring the data on the DL of the fronthaul interface via RDMA from the first memory of the distributed device to the second memory of the radio device can include a single RDMA write operation.

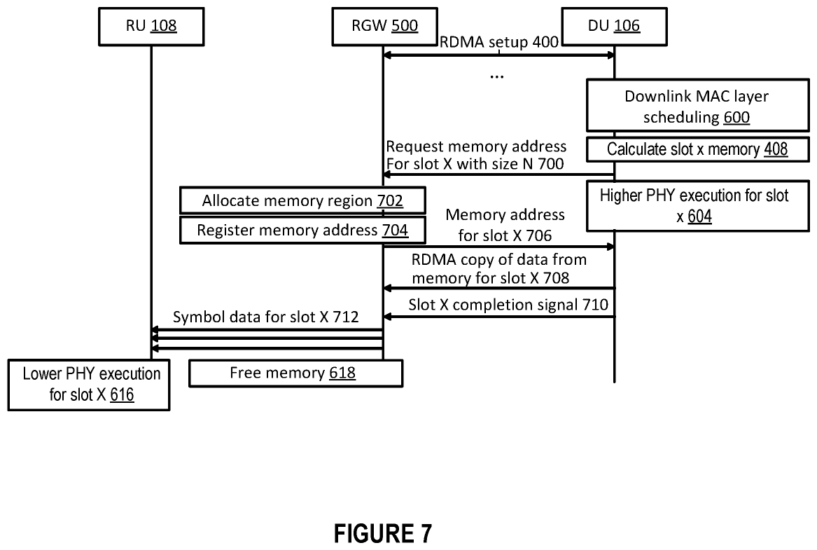

FIG. 7 is a sequence diagram showing an example of how a radio gateway 500 can be used in case a RU cannot perform RDMA operations. As discussed with respect to FIG. 5, RGW 500 can be an individual server or a SmartNIC, for example. In the example in FIG. 7, in operation 700, RGW 500 receives a request from DU 106 for a memory address for slot X with size N. In operations 702 and 704, the RDMA memory is allocated and the memory address registered by RGW 500. In operation 706, RGW 500 sends the memory address for slot X to DU 106. After the completion of the RDMA transfer of operations 708 and 710, in operation 712, RGW 500 can use a traditional fronthaul solution (e.g., eCPRI messages in case of O-RAN) to send the symbols for slot X to the RU 107.

In some embodiments, performing (operation 902 in FIG. 9) includes transferring the data on a DL of the fronthaul interface via RDMA from the first memory of the distributed device to the second memory of the radio gateway.

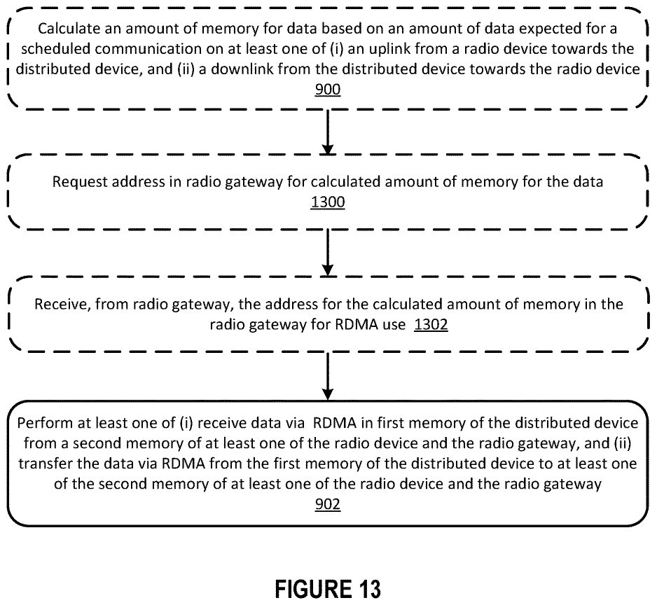

Referring to FIG. 13, the method can further include requesting (1300) an address in the radio gateway for the calculated amount of memory for the data; and receiving (1302), from the radio gateway, the address for the calculated amount of memory in the radio gateway for RDMA use.

The calculated amount of memory can include at least one of (i) an amount of memory in the second memory of the radio gateway, (ii) a maximum amount of data in the second memory of the radio gateway, (iii) at least one memory pool for the data, and (iv) a plurality of regions in the second memory of the radio gateway.

The address can include at least one of (i) a memory address in the radio gateway for the RDMA, (ii) an identifier of a location in the second memory of the radio gateway for the RDMA, and (iii) a plurality of memory addresses in the radio gateway for the RDMA.

Transferring the data on the DL of the fronthaul interface via RDMA from the first memory of the distributed device to the second memory of the radio gateway can include a single RDMA write operation.

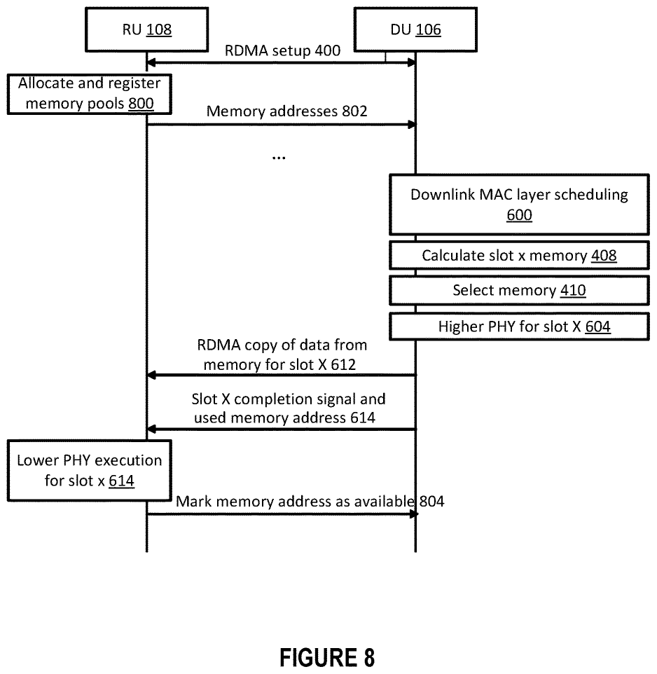

FIG. 8 is a sequence diagram showing an example that avoids a round-trip between the DU 106 and the RU 108 for each slot. In this example, in operation 800, one or more memory pools with multiple buffers are reserved and registered for RDMA in the RU 108. The allocated memory addresses are then provided, in operation 802, to the DU 106. In this example, once the size for slot X is calculated in operation 408, in operation 408 the DU 106 selects an appropriate memory region from the regions provided by the RU 108. After the RDMA copy in operation 612, as part of the signaling the DU 106 in operation 614 also notifies the RU 108 which region was used for slot X. After the execution of the lower physical layer functions of operation 614, in operation 804, the RU 108 marks the memory region as available in a message to the DU 106.

In some embodiments, performing (operation 902 in FIG. 9) includes transferring the data on a DL of the fronthaul interface via RDMA from the first memory of the distributed device to the second memory of the radio device, and the method further includes: receiving (1400) an address for one or more memory pools in the radio device for RDMA.

The method can further include selecting (1402) a memory pool from the one of more memory pools in the radio device for RDMA.

Transferring the data on the DL of the fronthaul interface via RDMA from the first memory of the distributed device to the second memory of the radio device can include a single RDMA write operation.

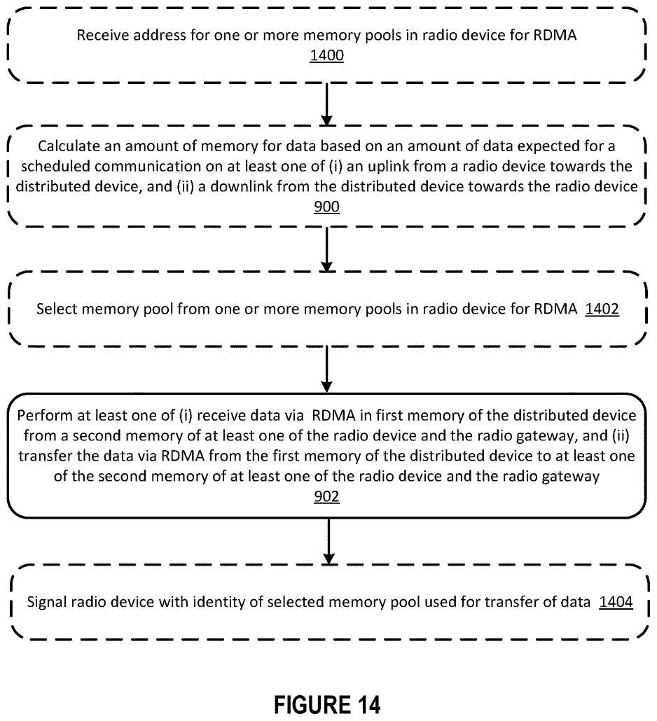

Referring to FIG. 14, in some embodiments, the method further includes signaling (1404) the radio device with an identity of the selected memory pool used for the transfer of the data.

In some embodiments, the first memory of the distributed device is included in an accelerator.

In some embodiments, the accelerator accesses the first memory.

Examples of the present disclosure can be used in O-RAN. For example, O-RAN currently defines eCPRI to be used between the RU and the DU for all exchange (including UE data transmitted on the PUSCH). The examples of FIGS. 4-8 herein include various example implementations of RDMA that may be used to extend/improve eCPRI and O-RAN. Such example implementations may be added to the standard, for example, and various vendors may implement methods and/or apparatus of the present disclosure.

Operations of a distributed device can be performed by the distributed device 106 of FIG. 3. Operations of the distributed device (implemented using the structure of FIG. 3) have been discussed with reference to the flow charts of FIGS. 9-14 according to some embodiments of the present disclosure. For example, a first memory 300, 302 connected to at least one processor 202 may perform respective operations of the flow charts.

In some embodiments of distributed devices and related methods, operations from the flow charts of FIGS. 9-14 may be optional. For example, the following operations may be optional: the operations of block 900 in FIG. 9; and the operations of blocks 900 and 1000-1006 in FIG. 10; the operations of blocks 900, 1000-1006, and 1100 in FIG. 11; the operations of blocks 900, 1200, and 1202 in FIG. 12; the operations of blocks 900, 1300, and 1302 in FIG. 13; and the operations of blocks 900 and 1400-1404 in FIG. 14.

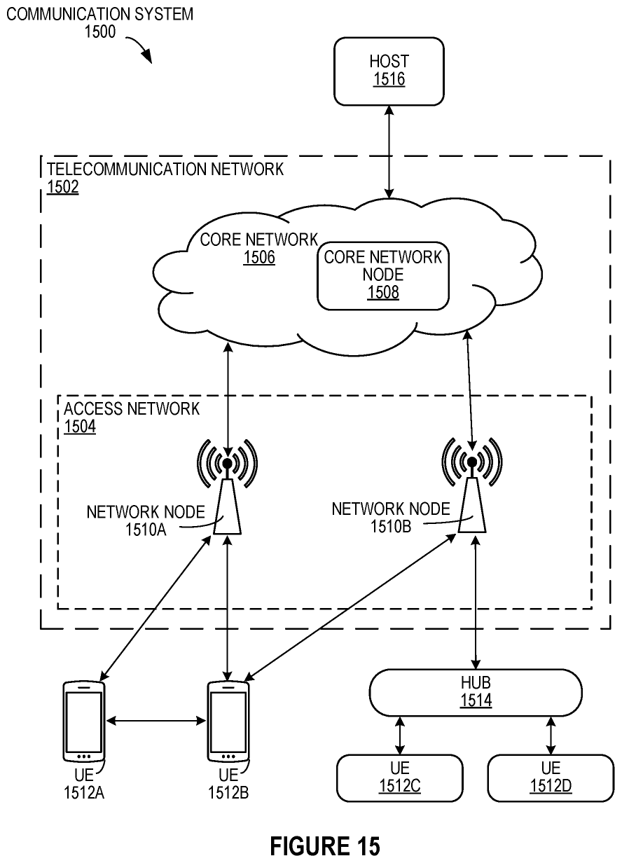

FIG. 15 shows an example of a communication system 1500 in accordance with some embodiments.

In the example, the communication system 1500 includes a telecommunication network 1502 that includes an access network 1504, such as a RAN, and a core network 1506, which includes one or more core network nodes 1508. The access network 1504 includes one or more access network nodes, such as network nodes 1510a and 1510b (one or more of which may be generally referred to as network nodes 1510), or any other similar 3^{rd} Generation Partnership Project (3GPP) access node or non-3GPP access point. The network nodes 1510 facilitate direct or indirect connection of UE, such as by connecting UEs 1512a, 1512b, 1512c, and 1512d (one or more of which may be generally referred to as UEs 1512) to the core network 1506 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1500 may include any number of wired or wireless networks, network nodes, UEs, and/or any other components or systems that may facilitate or participate in the communication of data and/or signals whether via wired or wireless connections. The communication system 1500 may include and/or interface with any type of communication, telecommunication, data, cellular, radio network, and/or other similar type of system.

The UEs 1512 may be any of a wide variety of communication devices, including wireless devices arranged, configured, and/or operable to communicate wirelessly with the network nodes 1510 and other communication devices. Similarly, the network nodes 1510 are arranged, capable, configured, and/or operable to communicate directly or indirectly with the UEs 1512 and/or with other network nodes or equipment in the telecommunication network 1502 to enable and/or provide network access, such as wireless network access, and/or to perform other functions, such as administration in the telecommunication network 1502.

In the depicted example, the core network 1506 connects the network nodes 1510 to one or more hosts, such as host 1516. These connections may be direct or indirect via one or more intermediary networks or devices. In other examples, network nodes may be directly coupled to hosts. The core network 1506 includes one more core network nodes (e.g., core network node 1508) that are structured with hardware and software components. Features of these components may be substantially similar to those described with respect to the UEs, network nodes, and/or hosts, such that the descriptions thereof are generally applicable to the corresponding components of the core network node 1508. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1516 may be under the ownership or control of a service provider other than an operator or provider of the access network 1504 and/or the telecommunication network 1502, and may be operated by the service provider or on behalf of the service provider. The host 1516 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1500 of FIG. 15 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1502 is a cellular network that implements 3GPP standardized features. Accordingly, the telecommunications network 1502 may support network slicing to provide different logical networks to different devices that are connected to the telecommunication network 1502. For example, the telecommunications network 1502 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1512 are configured to transmit and/or receive information without direct human interaction. For instance, a UE may be designed to transmit information to the access network 1504 on a predetermined schedule, when triggered by an internal or external event, or in response to requests from the access network 1504. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1514 communicates with the access network 1504 to facilitate indirect communication between one or more UEs (e.g., UE 1512c and/or 1512d) and network nodes (e.g., network node 1510b). In some examples, the hub 1514 may be a controller, router, content source and analytics, or any of the other communication devices described herein regarding UEs. For example, the hub 1514 may be a broadband router enabling access to the core network 1506 for the UEs. As another example, the hub 1514 may be a controller that sends commands or instructions to one or more actuators in the UEs. Commands or instructions may be received from the UEs, network nodes 1510, or by executable code, script, process, or other instructions in the hub 1514. As another example, the hub 1514 may be a data collector that acts as temporary storage for UE data and, in some embodiments, may perform analysis or other processing of the data. As another example, the hub 1514 may be a content source. For example, for a UE that is a VR headset, display, loudspeaker or other media delivery device, the hub 1514 may retrieve VR assets, video, audio, or other media or data related to sensory information via a network node, which the hub 1514 then provides to the UE either directly, after performing local processing, and/or after adding additional local content. In still another example, the hub 1514 acts as a proxy server or orchestrator for the UEs, in particular if one or more of the UEs are low energy IoT devices.

The hub 1514 may have a constant/persistent or intermittent connection to the network node 1510b. The hub 1514 may also allow for a different communication scheme and/or schedule between the hub 1514 and UEs (e.g., UE 1512c and/or 1512d), and between the hub 1514 and the core network 1506. In other examples, the hub 1514 is connected to the core network 1506 and/or one or more UEs via a wired connection. Moreover, the hub 1514 may be configured to connect to an M2M service provider over the access network 1504 and/or to another UE over a direct connection. In some scenarios, UEs may establish a wireless connection with the network nodes 1510 while still connected via the hub 1514 via a wired or wireless connection. In some embodiments, the hub 1514 may be a dedicated hub-that is, a hub whose primary function is to route communications to/from the UEs from/to the network node 1510b. In other embodiments, the hub 1514 may be a non-dedicated hub-that is, a device which is capable of operating to route communications between the UEs and network node 1510b, but which is additionally capable of operating as a communication start and/or end point for certain data channels.

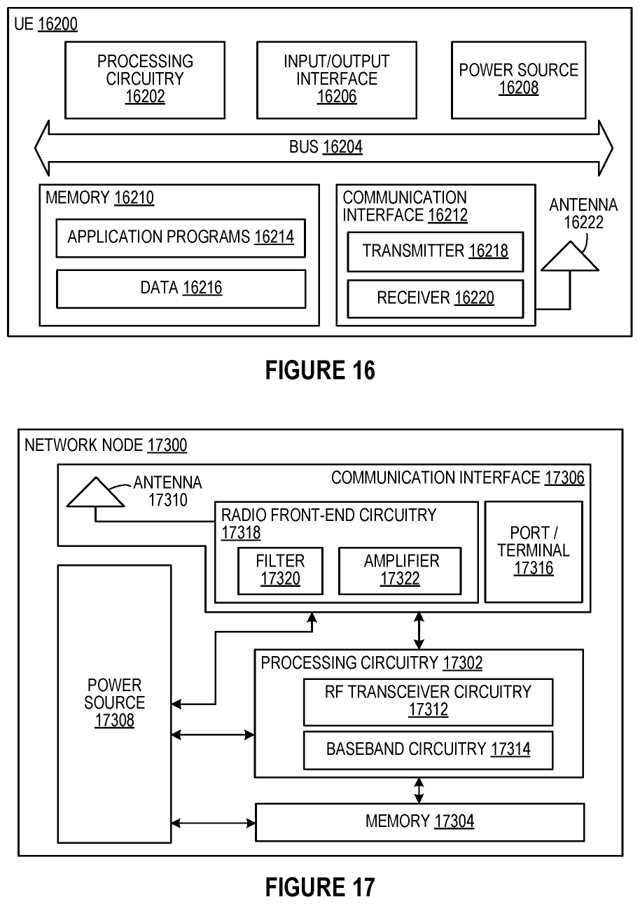

FIG. 16 shows a UE 16200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IOT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 16200 includes processing circuitry 16202 that is operatively coupled via a bus 16204 to an input/output interface 16206, a power source 16208, a memory 16210, a communication interface 16212, and/or any other component, or any combination thereof. Certain UEs may utilize all or a subset of the components shown in FIG. 16. The level of integration between the components may vary from one UE to another UE. Further, certain UEs may contain multiple instances of a component, such as multiple processors, memories, transceivers, transmitters, receivers, etc.

The processing circuitry 16202 is configured to process instructions and data and may be configured to implement any sequential state machine operative to execute instructions stored as machine-readable computer programs in the memory 16210. The processing circuitry 16202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 16202 may include multiple central processing units (CPUs).

In the example, the input/output interface 16206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 16200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 16208 is structured as a battery or battery pack. Other types of power sources, such as an external power source (e.g., an electricity outlet), photovoltaic device, or power cell, may be used. The power source 16208 may further include power circuitry for delivering power from the power source 16208 itself, and/or an external power source, to the various parts of the UE 16200 via input circuitry or an interface such as an electrical power cable. Delivering power may be, for example, for charging of the power source 16208. Power circuitry may perform any formatting, converting, or other modification to the power from the power source 16208 to make the power suitable for the respective components of the UE 16200 to which power is supplied.

The memory 16210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 16210 includes one or more application programs 16214, such as an operating system, web browser application, a widget, gadget engine, or other application, and corresponding data 16216. The memory 16210 may store, for use by the UE 16200, any of a variety of various operating systems or combinations of operating systems.

The memory 16210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 16210 may allow the UE 16200 to access instructions, application programs and the like, stored on transitory or non-transitory memory media, to off-load data, or to upload data. An article of manufacture, such as one utilizing a communication system may be tangibly embodied as or in the memory 16210, which may be or comprise a device-readable storage medium.

The processing circuitry 16202 may be configured to communicate with an access network or other network using the communication interface 16212. The communication interface 16212 may comprise one or more communication subsystems and may include or be communicatively coupled to an antenna 16222. The communication interface 16212 may include one or more transceivers used to communicate, such as by communicating with one or more remote transceivers of another device capable of wireless communication (e.g., another UE or a network node in an access network). Each transceiver may include a transmitter 16218 and/or a receiver 16220 appropriate to provide network communications (e.g., optical, electrical, frequency allocations, and so forth). Moreover, the transmitter 16218 and receiver 16220 may be coupled to one or more antennas (e.g., antenna 16222) and may share circuit components, software or firmware, or alternatively be implemented separately.

In the illustrated embodiment, communication functions of the communication interface 16212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 16212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IOT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 16200 shown in FIG. 16.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 17 shows a network node 17300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), BSs (e.g., radio base stations, Node Bs, evolved Node Bs (eNBs) and NR NodeBs (gNBs)).

BSs may be categorized based on the amount of coverage they provide (or, stated differently, their transmit power level) and so, depending on the provided amount of coverage, may be referred to as femto base stations, pico base stations, micro base stations, or macro base stations. A BS may be a relay node or a relay donor node controlling a relay. A network node may also include one or more (or all) parts of a distributed radio base station such as centralized digital units, DUs, and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 17300 includes a processing circuitry 17302, a memory 17304, a communication interface 17306, and a power source 17308. The network node 17300 may be composed of multiple physically separate components (e.g., a NodeB component and a RNC component, or a BTS component and a BSC component, etc.), which may each have their own respective components. In certain scenarios in which the network node 17300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 17300 may be configured to support multiple RATs. In such embodiments, some components may be duplicated (e.g., separate memory 17304 for different RATs) and some components may be reused (e.g., a same antenna 17310 may be shared by different RATs). The network node 17300 may also include multiple sets of the various illustrated components for different wireless technologies integrated into network node 17300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 17300.

The processing circuitry 17302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 17300 components, such as the memory 17304, to provide network node 17300 functionality.

In some embodiments, the processing circuitry 17302 includes a system on a chip. In some embodiments, the processing circuitry 17302 includes one or more of radio frequency (RF) transceiver circuitry 17312 and baseband processing circuitry 17314. In some embodiments, the radio frequency (RF) transceiver circuitry 17312 and the baseband processing circuitry 17314 may be on separate chips (or sets of chips), boards, or units, such as radio units and digital units. In alternative embodiments, part or all of RF transceiver circuitry 17312 and baseband processing circuitry 17314 may be on the same chip or set of chips, boards, or units.

The memory 17304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 17302. The memory 17304 may store any suitable instructions, data, or information, including a computer program, software, an application including one or more of logic, rules, code, tables, and/or other instructions capable of being executed by the processing circuitry 17302 and utilized by the network node 17300. The memory 17304 may be used to store any calculations made by the processing circuitry 17302 and/or any data received via the communication interface 17306. In some embodiments, the processing circuitry 17302 and memory 17304 is integrated.

The communication interface 17306 is used in wired or wireless communication of signaling and/or data between a network node, access network, and/or UE. As illustrated, the communication interface 17306 comprises port(s)/terminal(s) 17316 to send and receive data, for example to and from a network over a wired connection. The communication interface 17306 also includes radio front-end circuitry 17318 that may be coupled to, or in certain embodiments a part of, the antenna 17310. Radio front-end circuitry 17318 comprises filters 17320 and amplifiers 17322. The radio front-end circuitry 17318 may be connected to an antenna 17310 and processing circuitry 17302. The radio front-end circuitry may be configured to condition signals communicated between antenna 17310 and processing circuitry 17302. The radio front-end circuitry 17318 may receive digital data that is to be sent out to other network nodes or UEs via a wireless connection. The radio front-end circuitry 17318 may convert the digital data into a radio signal having the appropriate channel and bandwidth parameters using a combination of filters 17320 and/or amplifiers 17322. The radio signal may then be transmitted via the antenna 17310. Similarly, when receiving data, the antenna 17310 may collect radio signals which are then converted into digital data by the radio front-end circuitry 17318. The digital data may be passed to the processing circuitry 17302. In other embodiments, the communication interface may comprise different components and/or different combinations of components.

In certain alternative embodiments, the network node 17300 does not include separate radio front-end circuitry 17318, instead, the processing circuitry 17302 includes radio front-end circuitry and is connected to the antenna 17310. Similarly, in some embodiments, all or some of the RF transceiver circuitry 17312 is part of the communication interface 17306. In still other embodiments, the communication interface 17306 includes one or more ports or terminals 17316, the radio front-end circuitry 17318, and the RF transceiver circuitry 17312, as part of a radio unit (not shown), and the communication interface 17306 communicates with the baseband processing circuitry 17314, which is part of a digital unit (not shown).

The antenna 17310 may include one or more antennas, or antenna arrays, configured to send and/or receive wireless signals. The antenna 17310 may be coupled to the radio front-end circuitry 17318 and may be any type of antenna capable of transmitting and receiving data and/or signals wirelessly. In certain embodiments, the antenna 17310 is separate from the network node 17300 and connectable to the network node 17300 through an interface or port.

The antenna 17310, communication interface 17306, and/or the processing circuitry 17302 may be configured to perform any receiving operations and/or certain obtaining operations described herein as being performed by the network node. Any information, data and/or signals may be received from a UE, another network node and/or any other network equipment. Similarly, the antenna 17310, the communication interface 17306, and/or the processing circuitry 17302 may be configured to perform any transmitting operations described herein as being performed by the network node. Any information, data and/or signals may be transmitted to a UE, another network node and/or any other network equipment.

The power source 17308 provides power to the various components of network node 17300 in a form suitable for the respective components (e.g., at a voltage and current level needed for each respective component). The power source 17308 may further comprise, or be coupled to, power management circuitry to supply the components of the network node 17300 with power for performing the functionality described herein. For example, the network node 17300 may be connectable to an external power source (e.g., the power grid, an electricity outlet) via an input circuitry or interface such as an electrical cable, whereby the external power source supplies power to power circuitry of the power source 17308. As a further example, the power source 17308 may comprise a source of power in the form of a battery or battery pack which is connected to, or integrated in, power circuitry. The battery may provide backup power should the external power source fail.

Embodiments of the network node 17300 may include additional components beyond those shown in FIG. 17 for providing certain aspects of the network node's functionality, including any of the functionality described herein and/or any functionality necessary to support the subject matter described herein. For example, the network node 17300 may include user interface equipment to allow input of information into the network node 17300 and to allow output of information from the network node 17300. This may allow a user to perform diagnostic, maintenance, repair, and other administrative functions for the network node 17300.

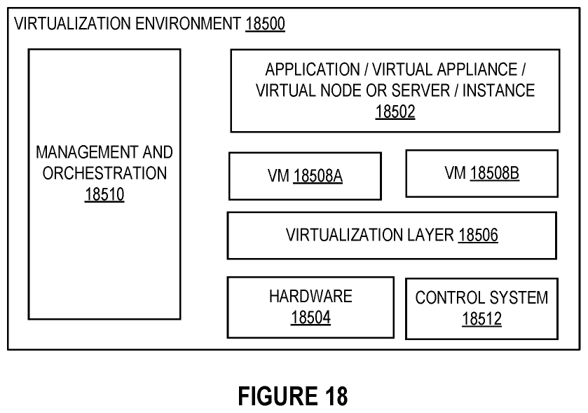

FIG. 18 is a block diagram illustrating a virtualization environment 18500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 18500 hosted by one or more of hardware nodes, such as a hardware distributed device that operates as a network node, UE, core network node, or host. Further, in embodiments in which the virtual node does not require radio connectivity (e.g., a core network node or host), then the node may be entirely virtualized.

Applications 18502 (which may alternatively be called software instances, virtual appliances, network functions, virtual nodes, virtual network functions, etc.) are run in the virtualization environment 18500 to implement some of the features, functions, and/or benefits of some of the embodiments disclosed herein.

Hardware 18504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 18506 (also referred to as hypervisors or virtual machine monitors (VMMs)), provide VMs 18508a and 18508b (one or more of which may be generally referred to as VMs 18508), and/or perform any of the functions, features and/or benefits described in relation with some embodiments described herein. The virtualization layer 18506 may present a virtual operating platform that appears like networking hardware to the VMs 18508.

The VMs 18508 comprise virtual processing, virtual memory, virtual networking or interface and virtual storage, and may be run by a corresponding virtualization layer 18506. Different embodiments of the instance of a virtual appliance 18502 may be implemented on one or more of VMs 18508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 18508 may be a software implementation of a physical machine that runs programs as if they were executing on a physical, non-virtualized machine. Each of the VMs 18508, and that part of hardware 18504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 18508 on top of the hardware 18504 and corresponds to the application 18502.

Hardware 18504 may be implemented in a standalone network node with generic or specific components. Hardware 18504 may implement some functions via virtualization. Alternatively, hardware 18504 may be part of a larger cluster of hardware (e.g. such as in a data center or CPE) where many hardware nodes work together and are managed via management and orchestration 18510, which, among others, oversees lifecycle management of applications 18502. In some embodiments, hardware 18504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 18512 which may alternatively be used for communication between hardware nodes and radio units.

Although the distributed devices described herein (e.g., distributed units, DUs, etc.) may include the illustrated combination of hardware components, other embodiments may comprise distributed devices with different combinations of components. It is to be understood that these distributed devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the distributed device, and/or performing one or more operations based on the obtained information or converted information, and as a result of said processing making a determination. Moreover, while components are depicted as single boxes located within a larger box, or nested within multiple boxes, in practice, distributed devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the distributed device, but are enjoyed by the distributed device as a whole, and/or by end users and a wireless network generally.

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A method performed by a distributed device communicatively connected to at least one of a radio device and radio gateway over a fronthaul interface in a telecommunication network, the method comprising:
performing at least one of the following (i) receiving data via remote direct memory access, RDMA, in a first memory of the distributed device from a second memory of at least one of the radio device and the radio gateway, and (ii) transferring the data via RDMA from the first memory of the distributed device to at least one of the second memory of at least one of the radio device and the radio gateway.

2. The method of claim 1, further comprising:
calculating an amount of memory for the data based on an amount of the data expected for a scheduled communication on at least one of (i) an uplink from the radio device towards the distributed device, and (ii) a downlink from the distributed device towards the radio device.

3. The method of claim 1, wherein the performing comprises receiving the data on an uplink of the fronthaul interface via RDMA from the second memory of at least one of the radio device and the radio gateway to the first memory of the distributed device.

4. The method of claim 2, further comprising:
reserving the amount of calculated memory in the distributed device; and
identifying an address for the reserved amount of memory for RDMA use.

5. (canceled)

6. The method of claim 4, wherein the reserving an amount of memory comprises at least one of (i) reserving an amount of memory in the first memory of the distributed device, (ii) reserving a maximum amount of data in the first memory, (iii) reserving at least one memory pool for the data, and (iv) reserving a plurality of memory pools in the first memory of the distributed device.

7. The method of claim 4, wherein the identifying the address comprises at least one of (i) identifying a memory address in the distributed device for the RDMA, (ii) identifying an identifier of a location in the first memory of the distributed device for the RDMA, and (iii) identifying a plurality of memory addresses in the distributed device for the RDMA.

8. The method of claim 3, further comprising:
signalling, to the radio device, the address for the reserved amount of memory in the distributed device for RDMA use.

9. The method of claim 3, wherein the receiving the data on the uplink of the fronthaul interface via RDMA in the first memory of the distributed device comprises a single RDMA write operation.

10-16. (canceled)

17. The method of claim 1, wherein the performing comprises transferring the data on a downlink of the fronthaul interface via RDMA from the first memory of the distributed device to the second memory of at least one of the radio device and the radio gateway.

18. The method of claim 17, further comprising:
requesting an address in the radio device for the calculated amount of memory for the data; and
receiving, from the radio device, the address for the calculated amount of memory in the radio device for RDMA use.

19. The method of claim 17, wherein the calculated amount of memory comprises at least one of (i) an amount of memory in the second memory of the radio device, (ii) a maximum amount of data in the second memory of the radio device, (iii) at least one memory pool for the data, and (iv) a plurality of regions in the second memory of the radio device.

20. The method of claim 18, wherein the address comprises at least one of (i) a memory address in the radio device for the RDMA, (ii) an identifier of a location in the second memory of the radio device for the RDMA, and (iii) a plurality of memory addresses in the radio device for the RDMA.

21. The method of claim 17, wherein the transferring the data on the downlink of the fronthaul interface via RDMA from the first memory of the distributed device to the second memory of the radio device comprises a single RDMA write operation.

22-26. (canceled)

27. The method of claim 1, wherein the performing comprises transferring the data on a downlink of the fronthaul interface via RDMA from the first memory of the distributed device to the second memory of the radio device, and the method further comprising:
receiving an address for one or more memory pools in the radio device for RDMA.

28. The method of claim 27, further comprising:
selecting a memory pool from the one of more memory pools in the radio device for RDMA.

29. The method of claim 27, wherein the transferring the data on the downlink of the fronthaul interface via RDMA from the first memory of the distributed device to the second memory of the radio device comprises a single RDMA write operation.

30. The method of claim 28, further comprising:
signaling the radio device with an identity of the selected memory pool used for the transfer of the data.

31. The method of claim 1, wherein the first memory of the distributed device is included in an accelerator.

32. The method of claim 31, wherein the accelerator accesses the first memory.

33. A distributed device comprising:
at least one processor; and
a first memory, connected to the at least one processor to perform operations comprising:
perform at least one of the following (i) receive data via remote direct memory access, RDMA, in the first memory of the distributed device from a second memory of at least one of a radio device and a radio gateway, and (ii) transferring the data via RDMA from the first memory of the distributed device to at least one of the second memory of at least one of the radio device and the radio gateway.

34-38. (canceled)

39. The distributed device of claim 33, wherein the receiving the data on the uplink of the fronthaul interface via RDMA in the first memory of the distributed device comprises a single RDMA write operation.
